(19) United States
(12) Patent Application Publication
(10) Pub. No.: US 2010/0103321 A1
(43) Pub. Date: Apr. 29, 2010

(54) AV PROCESSING APPARATUS AND PROGRAM

(75) Inventors: Kazuo Ishikawa, Saitama (JP); Yoshitaka Nojima, Saitama (JP); Toru Ebata, Saitama (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/530,441

(22) PCT Filed: Mar. 9, 2007
(86) PCT No.: PCT/JP2007/000196

§ 371 Date: Sep. 8, 2009

(51) Int. Cl. H04N 9/67; G06F 3/041

(52) U.S. Cl. 348/659; 345/173

(57) ABSTRACT

Provided herein is an AV processing apparatus which displays a plurality of video signal designating areas which are used to designate an output of each video signal on a touch panel in accordance to a plurality of input video signals, performs a mixing process based on a touch position on the touch panel, and performs a switching process of video signals based on a movement of the touch position.

### TECHNICAL FIELD

The present invention relates to an AV processing apparatus and a program which perform edit processes to AV signals as audio signals or video signals.

### BACKGROUND ART

In recent years, there has been known an audio signal processing apparatus which adjusts two types of audio signals simultaneously, in which a moving element (a tab or a grip element) is moved within a moving range between an A-terminal and a B-terminal (for example, Patent Document 1). This kind of audio signal processing apparatus is usually referred as “cross fader”. The cross fader is configured such that when the moving element is moved from the A-terminal towards the B-terminal, sound volume of the first audio signal is made bigger, and on the other hand, when the moving element is moved from the B-terminal towards the A-terminal, sound volume of the second audio signal is made bigger. Thus, a mixture rate of the two types of audio signals is determined based on a position of the moving element. This kind of audio signal adjustment apparatus is frequently adapted to DJ equipment (equipment used for audio performance by a disk jockey (DJ)) used in a club or the like and versatile music expressions are desired.

Also, in recent years, there has been known a video signal processing apparatus in which the above audio signal processing apparatus is applied to video signals, and which can determine a mixture rate of two types of video signals. This kind of video signal processing apparatus is also frequently adapted to VJ equipment (equipment used for video performance by a visual jockey or a video jockey (VJ)) which is used for displaying diversified videos on a monitor in a hall of a club or the like. Versatile video expressions are desired as well as the above DJ equipment.

### [Patent Document 1] JP-A-2004-5987.

### DISCLOSURE OF THE INVENTION

### Problems to be Solved

However, as the above audio signal processing apparatus and video signal processing apparatus determine the mixture rate of the two types of signals according to the position of the moving element, it is only possible to switch these two types of signals consecutively. More specifically, when a signal A is switched to a signal B or vice versa, such as “the signal A→the signals A+B→the signal B→the signals A+B→the signal A”, the signal A and the signal B are necessarily mixed, which indicates that it is not possible to switch from the signal A to the signal B directly. Therefore, an intuitive operation can not be performed by DJs or VJs who perform music or video expressions adapted to an atmosphere of the hall based on an instantaneous judgment, leading to poor usability.

There is a case in which three or more than three types of signals are mixed as method of the music expression or the video expression. In a case the method is achieved by the above audio signal processing apparatus or the video signal processing apparatus, faders are needed as the same numbers of signals, operations therefor become complex and a physical limitation of an arrangement region of faders must be considered, resulting in an impractical method. Further, in a case that three or more than three types of signals are switched, three faders must be operated, leading to poor operability.

The invention provides an AV processing apparatus and a program which enable a user to operate an edit process easily and intuitively by which a plurality of AV signals such as audio signals or video signals are mixed or switched, in view of the above problems.

### Means to Solve the Problems

An AV processing apparatus of the invention has: an input unit which is used to receive a plurality of AV signals as an audio signal or a video signal; an operating unit which includes a touch panel having a display function and is used for an edit operation of a plurality of AV signals with the touch panel having the display function; a display control unit which controls to display on the touch panel having the display function; an output AV signal generating unit which performs edit processes including a mixing process and a switching process on a plurality of AV signals based on the edit operation by the operating unit, and generates an output AV signal as an output object; and an output unit which outputs the output AV signal generated by the output AV signal generating unit. The display control unit displays a plurality of AV signal designating areas which is used to designate an output of each AV signal on the touch panel having the display function corresponding to a plurality of AV signals input from the input unit. The output AV signal generating unit performs the mixing process of a plurality of AV signals based on a touch position on the touch panel having the display function and performs the switching process of a plurality of AV signals based on a movement of the touch position.

With this configuration, the touch panel having the display function displays a plurality of AV signal designating areas, and the mixing process and the switching process can be performed based on the touch position or the movement of the touch position on the touch panel having the display function. In other words, as an AV signal designating area is touched, an AV signal corresponding to the area is output mainly. As the touch position is moved between two AV signal designating areas, two AV signals can be switched, thereby the edit process can be easily performed with an intuitive operation.

The mixing process indicates that, for example, a plurality of AV signals are blended by a fader method and a video based on two video signals is wiped. The switching process indicates that the above mixing process is performed consecutively.

In the above described AV processing apparatus, it is preferable that the display control unit determine arrangements of a plurality of AV signal designating areas based on the number of the AV signals input from the input unit.

With this configuration, a plurality of AV signal designating areas can be arranged properly based on the number of AV signals. In this case, it is preferable that all the AV signal designating areas be adjacent one another. It is further preferable that the distances among adjacent AV signal designating areas be equal wherever possible. For example, in a case that three AV signals are input, it is possible to make the distances among the three AV signal designating areas equal by arranging the three AV signal designating areas at positions corresponding to each apex of an equilateral triangle, leading to good operability.

In the above described AV processing apparatus, it is preferable that the display control unit display a video of a video signal on a corresponding AV signal designating area when the AV signal is the video signal.

With this configuration, in a case that the AV signal as an edit object is the video signal, its' video is displayed on the touch panel having the display function. Therefore, the video signal corresponding to its' AV signal designating area is output mainly by touching the video itself which is desired to be output, thereby the intuitive operation can be made.

Also, in a case that the AV signal is an audio signal, it is preferable that information specifying the audio signal be displayed in a corresponding to AV signal designating area. With this configuration, regardless of types of signals, the intuitive operation can be performed.

In the above described AV processing apparatus, it is preferable that each AV signal designating area have a reference point as reference which is used to determine the mixing rate in the mixing process and the switching rate in the switching process, and the output AV signal generating unit determines the mixing rate or the switching rate of each AV signal corresponding to each AV signal designating area based on a distance between the touch position and each reference point provided in each AV signal designating area with respect to the touch position or the movement of the touch position.

With this configuration, it is possible to determine the mixing rate or the switching rate of each AV signal corresponding to each AV signal designating area based on the distance between an operation point and each reference point. For example, in a case that the reference point is positioned at the center of the area, the mixing rate or the switching rate of the output AV signal can be changed depending on when the center is touched or when a corner of the area is touched, even within a same AV signal designating area. Accordingly, usability is enhanced in a case that more variable output AV signal needs to be generated and more smoothly switching of AV signals needs to be performed.

In the above described AV processing apparatus, it is preferable that the output AV signal generating unit set the output of the AV signal corresponding to the AV signal designating area at 100% with respect to the touch position or the movement of the touch position inside the AV signal designating area, and determine the mixing rate or the switching rate of each AV signal corresponding to each AV signal determining area based on a minimum distance from the touch position to each AV signal designating area with respect to the touch position or the movement of the touch position outside the AV signal designating area.

With this configuration, regarding the operation within the AV signal designating area, the output of the AV signal corresponding to the AV signal designating area is set at 100%, and regarding an operation outside the AV signal designating area, the mixing rate or the switching rate of each AV signal corresponding to each AV signal determining area are determined based on the minimum distance from the touch position to each AV signal designating area. In other words, the AV signal only can be output with respect to the operation within the AV signal designating area, and the mixing process and the switching process of AV signals can be performed only with respect to the operation outside the AV signal designating area. Therefore, even a beginner can easily operate without an instruction manual.

In this case, it is preferable that each AV signal designating area be apart from one another. With this configuration, a separate area between two AV signal designating areas (an area outside AV signal designating areas) allows to perform the mixing process and the switching process of the two AV signal, thereby the intuitive operation can be performed.

In the above described AV processing apparatus, it is preferable that each AV signal designating area have a reference point as reference which is used to determine the mixing rate in the mixing process and the switching rate in the switching process. An operation mode setting unit is provided which sets either the first operation mode or the second operation mode. The first operation mode determines the mixing rate or the switching rate of each AV signal corresponding to each AV signal designating area based on a distance between the touch position and each reference point provided in each AV signal designating area with respect to the touch position or the movement of the touch position. The second operation mode sets the output of the AV signal corresponding to the AV signal designating area at 100% with respect to the touch position or the movement of the touch position inside the AV signal designating area and determines the mixing rate or the switching rate of each AV signal corresponding to each AV signal designating area based on the minimum distance from the touch position to each AV signal designating area with respect to the touch position or the movement of the touch position outside the AV signal designating area. The output AV signal generating unit performs the mixing process or the switching process based on a setting by the operation mode setting unit.

With this configuration, it is possible to set either the first operation mode or the second operation mode according to user's needs or application. It is possible to enhance general versatility of the apparatus by letting professional-oriented users who need to generate more variable output AV signal or perform switching of AV signals more smoothly select the first operation mode and by letting beginners who need easy operations select the second operation mode.

In the above described AV processing apparatus, it is preferable that the apparatus further have an arrangement change instructing unit which is used to instruct an arrangement change of each AV signal designating area on the touch panel having the display function. It is also preferable that the display control unit change an arrangement of one or more AV signal designating areas corresponding to one or more AV signals included in the output AV signal at around the center with respect to other AV signal designating areas based on an instruction by the arrangement change instructing unit.

With this configuration, it is possible to enhance operability by arranging the AV signal designating area corresponding to the AV signal (output AV signal) as a currently edit object at around the center with respect to other AV signal designating areas. For example, in a case that the output AV signal is a video signal and a video of the video signal is wiped to another video, it is easily possible to switch any other video because the AV signal designating areas corresponding to other video signals are arranged therearound. Also, the AV signal designating area corresponding to the AV signal as an edit object can not, be lost even if a finger takes off from the touch panel having the display function.

The arrangement change instructing unit may be configured to be instructed with the touch panel having the display function or with other operating element (a operating key or a button or the like) other than the touch panel having the display function.

In the above described AV processing apparatus, it is preferable that the edit process include an effect process which applies an effect on the output AV signal. It is also preferable that the display control unit display one or more effect designating areas provided per effect on the touch panel having the display function, and the output AV signal generating unit perform the effect process on the output AV signal based on the touch position or the movement of the touch position on the touch panel having the display function.

With this configuration, it is possible to operate the effect process intuitively besides the mixing process and the switching process. The effect process can be achieved such that the effect corresponding to the effect designating area is applied to the output AV signal, for example, when inside the effect designating area is touched, and that an effect applying rate is increased based on a distance between the touch position and the effect designating area when the movement of the touch position approaches the effect designating area.

A program according to the invention causes a computer to function as each unit in the above described AV processing apparatus.

It is possible to realize the AV processing apparatus which allows users to operate easily and intuitively the edit operation including the edit processes such as mixing or switching a plurality of AV signals as an audio signal or a video signal.

### BRIEF DESCRIPTION OF THE DRAWINGS

FIG. 1A shows a system structure of an AV processing system according to one embodiment of the invention.

FIG. 1B shows a simplified structure of the AV processing apparatus.

FIG. 2 shows a user interface provided on the AV processing apparatus.

FIG. 3 is a block diagram of the AV processing apparatus.

FIGS. 4A and 4B show arrangement examples of video signal designating areas on a touch panel.

FIG. 5 is an explanatory view of the first operation

FIG. 6 is an explanatory view of the second operation mode.

FIGS. 7A and 7B are explanatory views of an arrangement change pattern 1.

FIGS. 8A and 8B are explanatory views of an arrangement change patterns 2 and 3, respectively.

FIG. 9 is a diagram showing a display example of the touch panel provided with an effect designating area.

FIGS. 10A and 10B are diagrams of another display examples of the touch panel.

### REFERENCE NUMERALS

10 CD player
20 DVD player
30 AV processing apparatus
33 micro-computer
34 signal processing unit
40 speaker
50 monitor
A audio signal designating area
BT1 arrangement change button
BT2 operation mode setting button
E effect designating area
SY AV processing system
P1-P4 reference point
T1-T9 touch position
TP touch panel
V video signal designating area

### BEST MODES FOR CARRYING OUT THE INVENTION

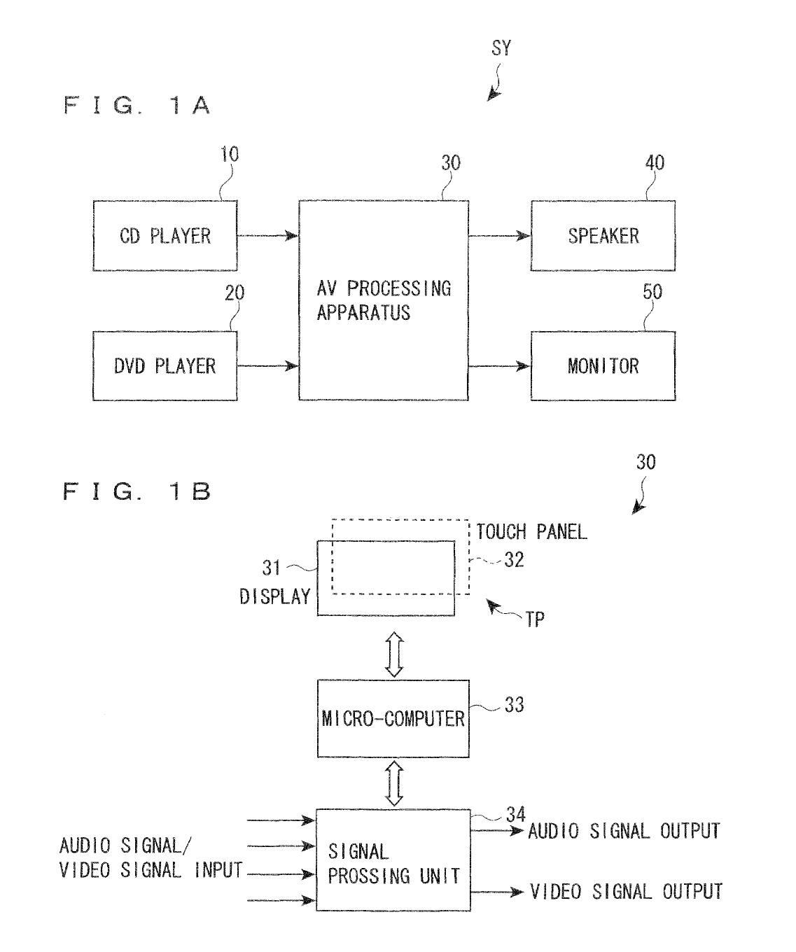

An AV processing apparatus and a program according to an embodiment of the invention will be explained hereinbelow with reference to accompanying drawings. FIG. 1A shows a system diagram of an AV processing system SY applied with an AV processing apparatus 30 of the invention. The AV processing system SY has: one or more CD players 10 (only one is shown in the figure) which generate one or more audio signals to be input to the AV processing apparatus 30; one or more DVD players 20 (only one is shown in the figure) which generate one or more video signals to be input to the AV processing apparatus 30; the AV processing apparatus 30 to which one or more audio signals and/or video signals (the audio signals and/or the video signals are refereed as “AV signal” hereinafter) are input to edit from these one or more CD players 10 and/or DVD players 20 and which generate output AV signals by editing the above signals; a speaker 40 which outputs the audio signals output from the AV processing apparatus 30; and a monitor 50 which displays the video signals output from the AV processing apparatus 30.

The AV processing apparatus 30 of the embodiment is capable of receiving a plurality of AV signals and performs various edit processes including a mixing process or a switching process of these AV signals. One example of the AV processing apparatus 30 is DVJ equipment used in a club or the like (composite equipment of DJ equipment used for an audio performance by disk jockeys (DJs) and VJ equipment used for a video performance by visual jockeys or video jockeys (VJs)) which is capable of dealing with the audio signals and/or the video signals and which applies effect and the like on both of the audio and the video as instrument.

The VJs and the DJs will be explained hereinbelow. The VJs mix (synthesize or link) videos in accordance with music extemporaneously. While the DJs mix music extemporaneously, the VJs perform using videos. The VJs perform to switch and output videos on a screen mainly in an event or a club party, and select appropriate videos extemporarily in accordance with music being played in a hall or project progress and shows the videos in good timing.

On the other hand, the DJs select music based on an atmosphere and reproduce continuous music. The DJs perform live performance manipulating a turn table and the like which can change pitch (speed) of music. Generally, the DJs perform such as DJ mix, scratch and the like in addition to music selection. In the mix performance, a current reproduced number is linked to a next reproduced number smoothly for avoiding discontinuity of sound, thereby tension of a floor is maintained.

In general, most performers are currently compartmentalized into VJ or DJ, specializing in a performance on either music or video. It is difficult for those specializing in a performance on either music or video to mix objects that are not their specialty. Even in a performance on either music or video, a variety of very hasty operations are required to give an impromptu performance and apply effects. This situation does not allow processing both music and video.

Both the VJs and the DJs, however, carry out such activities as outputting one piece of music or video after another at a good tempo to match the atmosphere of the venues or the performers' sense. Since it is necessary to harmonize the sounds to be provided with the videos to be provided, it is desirable that one person give both audio and video performances. The VJs who essentially specialize in video performances may easily process music if music changes with the change of videos; on the contrary, the DJs who essentially specialize in music may process sounds and videos altogether in a more spontaneous manner if videos change with the change of sounds.

The AV processing apparatus 30 according to the embodiment enables one person to process both videos and music that are essentially impossible for one person to process simultaneously. The AV processing apparatus 30 also provides easy and comfortable operability to one who try to process both music and videos.

For apparatuses generating the AV signals to be input to the AV processing apparatus 30, other apparatuses (e.g., various types of audio and video equipment, personal computers) besides CD players 10 and DVD players 20 may be used. The functions of CD players 10 and DVD players 20 may be included in the AV processing apparatus 30. Video signals may be moving images or still images. When a plurality of audio signals are input to the AV processing apparatus 30, it is preferred that the CD players 10 or AV processing apparatus 30 have a function to equalize the beats per minute (BPM) of such a plurality of audio signals.

FIG. 1B shows a simplified structure diagram of the AV processing apparatus 30 which has a touch panel TP with a display function, a micro-computer 33 and a signal processing unit 34 as a main structure element.

The touch panel TP with the display function includes a display 31 having a display element such as TFT, and a touch panel 32 superimposed thereon. As a user can operate the touch panel 32 on display of the display 31 by applying the touch panel TP having the display function, simple and intuitive operations can be achieved.

The micro-computer 33 detects a position and movement of an operation position according to voltage change based on an operation (touch) on the touch panel TP. Further, the micro-computer 33 generates a control signal for instructing an edit process of the input AV signals based on the detected result and outputs the signal to the signal processing unit 34 (an audio/video control device).

The signal processing unit 34 performs a mixing process or a switching process of each input AV signal based on the input control signal from the micro-computer 33, generates output audio signals and/or output video signals (referred as “output AV signal” hereinafter) based on the process result, and outputs each signal from each output interface.

Further, the signal processing unit 34 outputs information (for example, video data based on the video signals) regarding the each input AV signal to the micro-computer 33. The micro-computer 33 performs display control by which the information is displayed on a predetermined area of the touch panel TP (the display 31). The micro-computer 33 also performs integral control on the AV processing apparatus 30 such as information management based on user's operation and signal input/output with an external device as well as the above control.

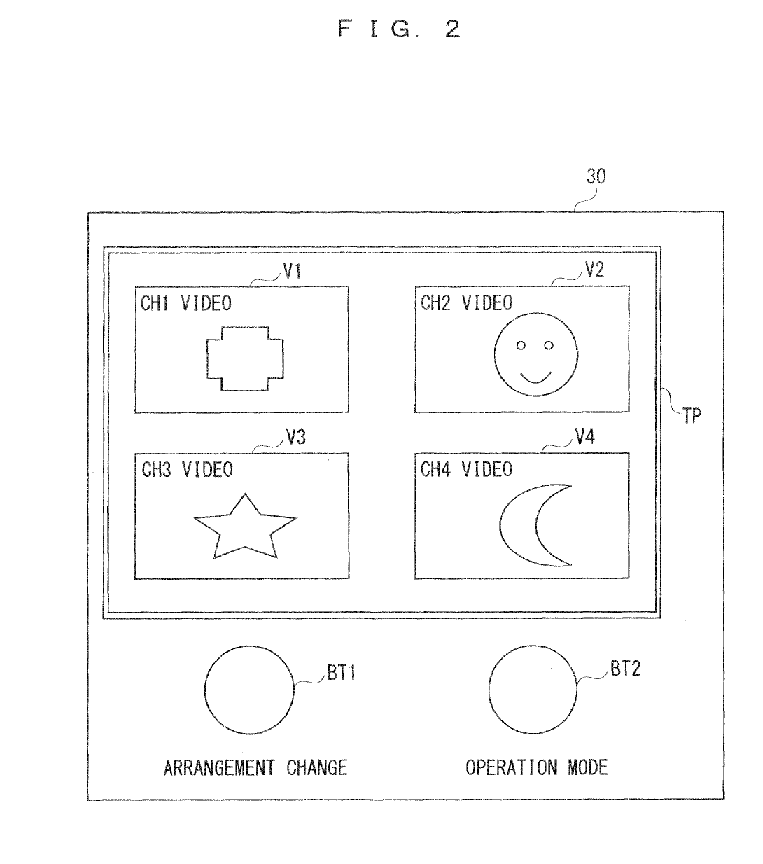

A user interface used for the AV processing apparatus 30 will be explained with reference to a plan view of FIG. 2. As shown in FIG. 2, the AV processing apparatus 30 has the above described touch panel TP on a top surface thereof, and two operation buttons BT1 and BT2. The AV processing apparatus 30 includes a confirmation display for letting the user confirm a video of the video signal included in the output AV signal, a fader for switching and adjusting the input signals and various operational elements for applying effect impact.

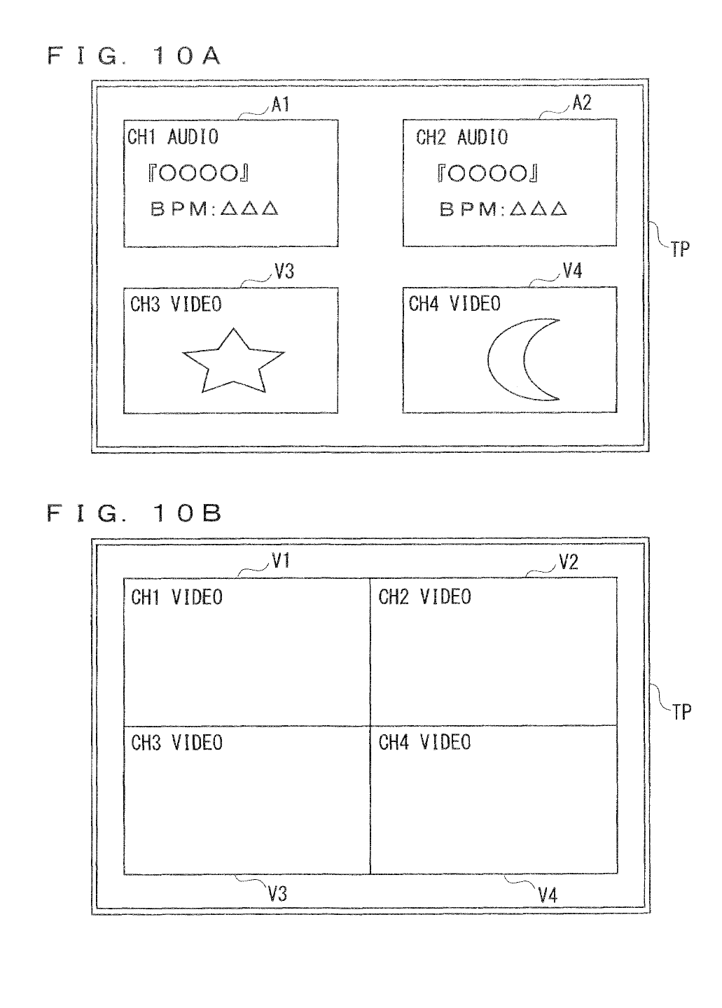

The touch panel TP displays a plurality of AV signal designating areas corresponding to the input plurality of AV signals. FIG. 2 shows an example in which four video signals are input and AV signal designating areas V1-V4 corresponding to the input video signals to channels 1-4 are displayed. It is referred that an AV signal designating area corresponding to a video signal is a video signal designating area V and an AV signal designating area corresponding to an audio signal is an audio signal designating area A (see FIG. 10A).

As shown in FIG. 2, four video signal designating areas V1-V4 are arranged such that distances among adjacent video signal designating areas V are approximately equal. Further, each of the video signal designating areas V1-V4 shows a channel number and a video of the corresponding video signal. With a state shown in FIG. 2, for example, when an inside of the video signal designating area V1 is touched, the video based on the video signal of channel 1 is output as main video. When a touch position is moved from the video signal designating area V1 towards the video signal designating area V2, the switching process from the channel 1 to the channel 2 is performed. According to an operation mode setting, a relationship between the touch position and an output AV signal varies, a detail of which will be explained later.

The operation button BT1 is an arrangement change button used for instructing arrangement change of the AV signal designating areas displayed on the touch panel TP. In a state that the AV signal is being output, when the arrangement change button BT1 is pressed by the user, a position of an AV signal designating area corresponding to the AV signal as an output object is changed at around the center with respect to other AV signal designating areas.

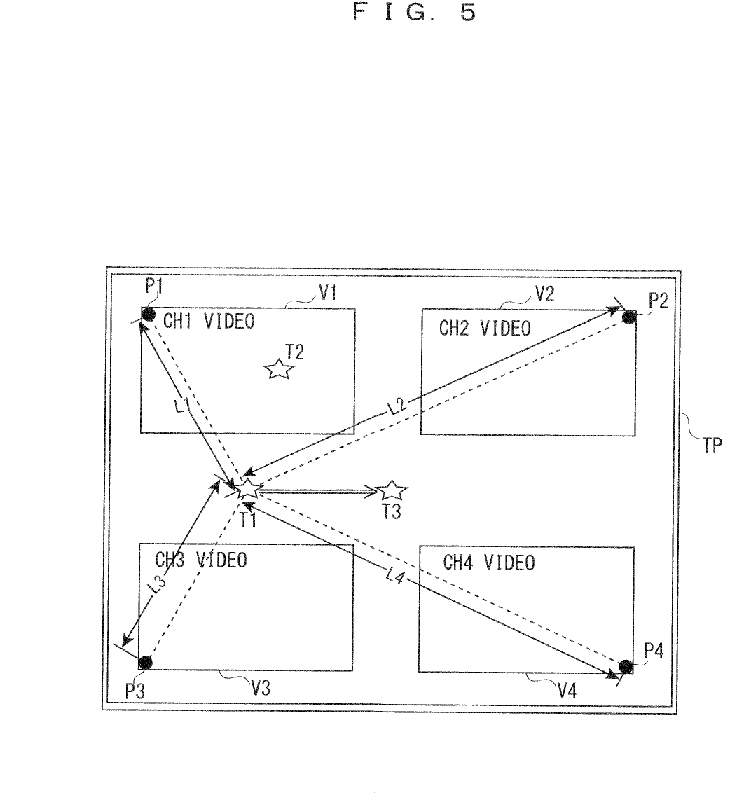

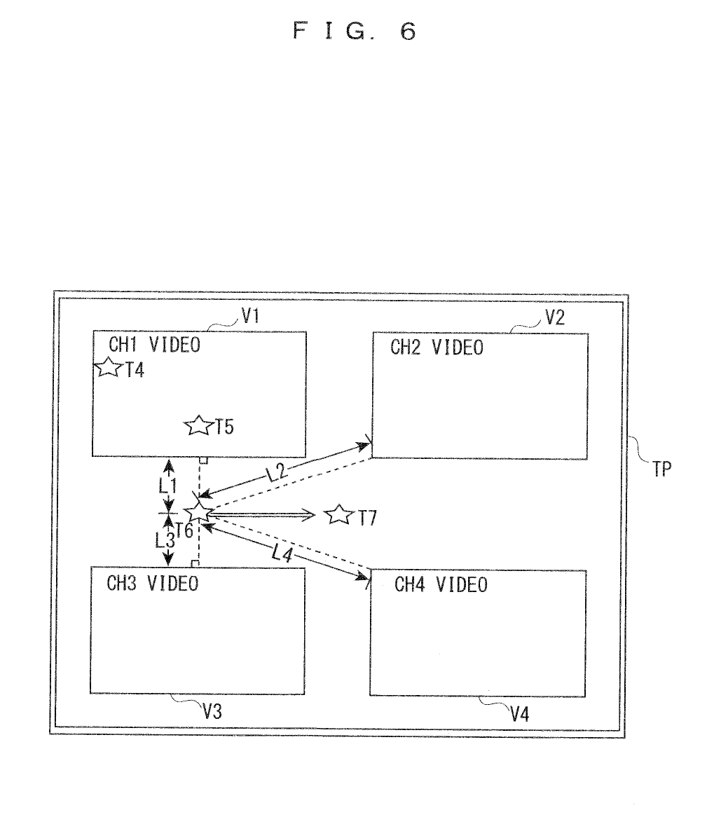

The operation button BT2 is an operation mode setting button for setting the above described operation mode. In the embodiment, either the first operation mode (see FIG. 5) or the second operation mode (see FIG. 6) can be set, and operation modes can be switched every time the operation mode setting button BT2 is pressed.

It may be possible to use other operation elements such as a rotary knob or a slider for an arrangement change instruction of AV signal designating areas and operation mode designation without limiting the above buttons.

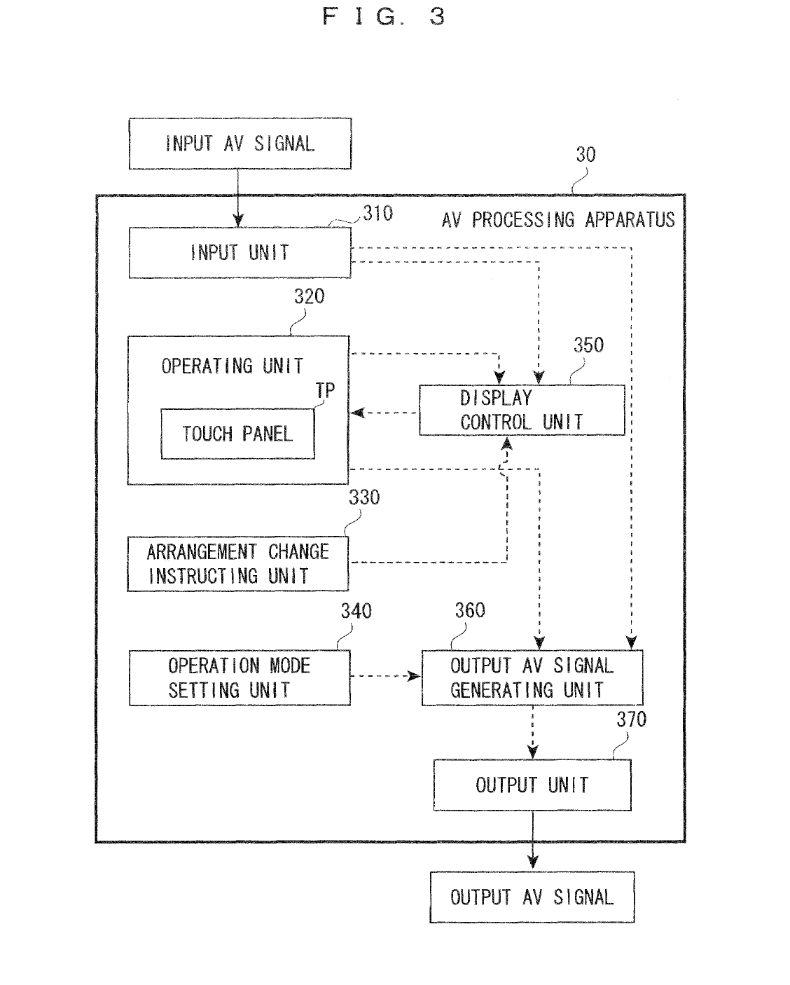

Referring to a block diagram shown in FIG. 3, a control structure of the AV processing apparatus 30 will be described. As shown in FIG. 3, the AV processing apparatus 30 has an input unit 310, an operating unit 320, an arrangement change instructing unit 330, an operation mode setting unit 340, a display control unit 350, an output AV signal generating unit 360 and an output unit 370.

The input unit 310 is used to be input a plurality of AV signals (input AV signals) and is constructed by a signal input interface (analog signal input terminals or a digital signal input terminals) (not shown) as a main element. The operating unit 320 is used by the user for an edit operation of the input plurality of AV signals and is constructed by the touch panel TP as a main element.

The arrangement change instructing unit 330 is used for instructing the arrangement change of the AV signal designating areas as described above, and is constructed by the arrangement change button BT1 as a main element (see FIG. 2). When the arrangement change by the arrangement change instructing unit 330 is instructed, the AV signal designating area corresponding to one or more AV signals included in the output AV signals is changed at about the center with respect to other AV signal designating areas by the display control unit 350 described later.

The operation mode setting unit 340 is used for setting either the first operation mode or the second operation mode as described above and is constructed by the operation mode setting button BT2 as a main element (see FIG. 2). In the first operation mode, a reference point P (see FIG. 5) is provided in each AV signal designating area and a mixing rate or a switching rate of each AV signal corresponding to each AV signal designating area is determined based on a distance between the touch position and each reference point P provided in each AV signal designating area. On the other hand, in the second operation mode, an output of an AV signal corresponding to the AV signal designating area is set at 100% regarding the touch position or the movement of the touch position inside the AV signal designating area. The mixing rate or the switching rate of each AV signal corresponding to each AV signal designating area is determined according to a minimum distance from a touch position to each AV signal designating area regarding the touch position or the movement of the touch position outside the AV signal designating area. Each of the operation modes will be explained later with a specific example.

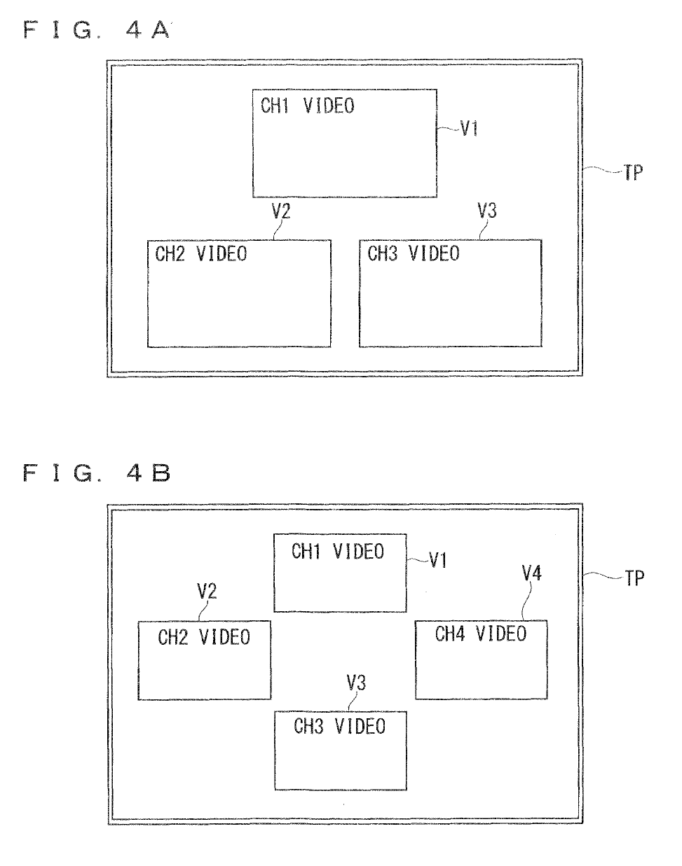

The display control unit 350 is used for display control of the touch panel TP and is constructed by the above micro-computer 33 and the signal processing unit 34 as main elements (see FIG. 1). The display control unit 350 displays an AV signal designating area corresponding to each AV signal on the touch panel TP, corresponding to a plurality of AV signals input by the input unit 310. At this time, the arrangement of each AV signal designating area is determined according to the number of input AV signals in consideration of operability and visual quality. For example, as shown in FIG. 4A, in a case that three video signals ch1-ch3 are input, it is possible to make the distances equal among three video signal designating areas V1-V3 by arranging the three video signal designating areas V1-V3 at positions corresponding to each apex of a regular triangle. On the other hand, as shown in FIG. 2, in the case that four video signals ch1-ch4 are input, it is possible to make the distances equal among four video signal designating areas V1-V4 by arranging the four video signal designating areas V1-V4 at positions corresponding to each apex of a rectangle in response to aspect ratio of each video signal designating area V.

It may be possible to determine the arrangement of each AV signal designating area by the number of AV signals selected by the user, rather than the number of the input AV signals. Also, in the case that four video signals ch1-ch4 are input, as shown in FIG. 4B, it may be possible to arrange the four video signal designating areas V1-V4 at positions corresponding to each apex of a rhombus. In this case, as shown in FIG. 4B, it is preferred that each area size be reduced so as not to overlap each video signal designating area V because of the arrangement change. It may be also possible to switch/select the arrangement of the AV signal designating areas among a plurality of arrangement candidates according to user's preference, by an operation such as longer press on the arrangement change button BT1.

The explanation will be back to FIG. 3. The output AV signal generating unit 360 performs various edit processes on a plurality of AV signals based on the edit operation by the operating unit 320 and generates the AV signal as an output object, and is constructed by the micro-computer 33 and the signal processing unit 34 as main elements (see FIG. 1B). As the edit processes, the mixing process of a plurality of AV signals based on the touch position of the touch panel TP and the switching process of a plurality of AV signals based on the movement of the touch position are performed. The mixing process indicates that, for example, a plurality of AV signals are blended by a fader method, a video based on two video signals is wiped or the like. The switching process indicates that the mixing process above is performed consecutively.

The output AV signal generating unit 360 switches control programs for performing the mixing process or the switching process (determination of the mixing rate or the switching rate) based on the setting by the operation mode setting unit 340 as described above, and performs these processes.

The output unit 370 is used for outputting the output AV signal generated by the output AV signal generating unit 360, and is constructed by the signal output interface (an analog or digital signal output terminal) (not shown) as a main element.

Each operation mode will be explained hereinbelow with reference to FIGS. 5 and 6. In the explanation below, a case in which the four video signals ch1-ch4 are input to the AV processing apparatus 30 is exemplified. FIG. 5 is an explanatory diagram of the first operation mode. When the first operation mode is set, the reference points P1-P4 as reference for determining the mixing rate or the switching rate are provided in each of the video signal designating areas V1-V4. The reference point P may be actually displayed or may not be displayed on the touch panel TP on user's operation.

In FIG. 5, the video signal designating area V1 displayed at an upper left on the touch panel TP has the reference point P1 at about an upper left corner of the rectangular area, the video signal designating area V2 displayed at an upper right on the touch panel TP has the reference point P2 at about an upper right corner of the rectangular area, the video signal designating area V3 displayed at a lower left on the touch panel TP has the reference point P3 at about a lower left corner of the rectangular area, and the video signal designating area V4 displayed at a lower right on the touch panel TP has the reference point P4 at about a lower right corner of the rectangular area.

For example, when a touch position T1 is touched, the mixing rate of the video signal of each channel is inversely proportional to the distances L1-L4 to each reference point. Therefore, in the example of FIG. 5, when the touch position T1 between the video signal designating area V1 and the video signal designating area V2 is touched, the output AV signal is generated with a mixing rate in which the ch1 and the ch3, and, the ch2 and the ch4 are approximately equal and the former two channels are mixed with higher rate than that of the latter two channels. In a case that a touch position T2 positioned within the video signal designating area V1 is touched, the mixing rate of the video signal of each channel is inversely proportional to the distance to each reference point.

Further, when the touch position is moved from the touch position T1 to the touch position T3, the switching rate is changed according to the movement. Therefore, in a case of the example FIG. 5, as the touch position is moved from the touch position T1 towards the touch position T3, the switching rates of the ch2 and the ch4 become higher, and as the touch position is moved at the touch position T3, the switching rates of all the channels become approximately equal. The switching rate is configured such that an amount of switching rates of all the channels is 100%.

Thus, in the first operation mode, the mixing rate and the switching rate are determined according to the distances from the reference point P regardless of the inside and outside the video signal designating area V. The mixing rate and the switching rate of each channel may be calculated according to a predetermined algorithm having a parameter based on the distance from each reference point P, rather than in inversely proportional to the distance from each reference point P. Further, in this case, a channel away from the reference point P more than a predetermined distance may not be counted as an object for mixing and switching.

Also, the position of the reference point P may be designated by the user and may be at a common position in all the video signal designating areas V (for example, at the center of each area). Additionally, display/non-display of the reference point P may be selected by the user.

Next, the second operation mode will be explained. In the second operation mode, a whole video signal designating area V is regarded as the reference point P, rather than that a point within the video signal designating area V is regarded as reference point P in the first operation mode. Therefore, when the touch positions T4 and T5 are touched, though the touch positions are different, both are within the video signal designating area V1, thereby an output (the mixing rate and the switching rate) of the ch1 is 100%.

On the other hand, as a touch position T6 is outside the video signal designating area V, the mixing rates or the switching rates of the ch1-4 are determined according to minimum distances (L1, L2, L3, L4) from the touch position T6 to each of the video signal designating areas V1-V4. A calculating method of the mixing rate or the switching rate is the same as that of the first operation mode, and a detailed explanation therefor is omitted. A change of the switching rate when the touch position is moved from the touch position T6 to the touch position T7 is the same as that of the first operation mode in which the touch position is moved from the touch position T1 to the touch position T3 (see FIG. 5).

Thus, in the second operation mode, the output of the video signal corresponding to the video signal designating area V is 100% within the video signal designating area V, and the mixing rate or the switching rate of each video signal corresponding to each video signal designating area V is determined according to the minimum distance from the touch position to each video signal designating area V.

The first and the second operation modes explained with FIGS. 5 and 6 may be set selectively according to user's needs or applications. In short, versatility of the AV processing apparatus 30 can be enhanced by letting professional-oriented users seeking for generating more variable output AV signal or performing switching of AV signals more smoothly select the first operation mode, and by letting beginners seeking for easy operations select the second operation mode.

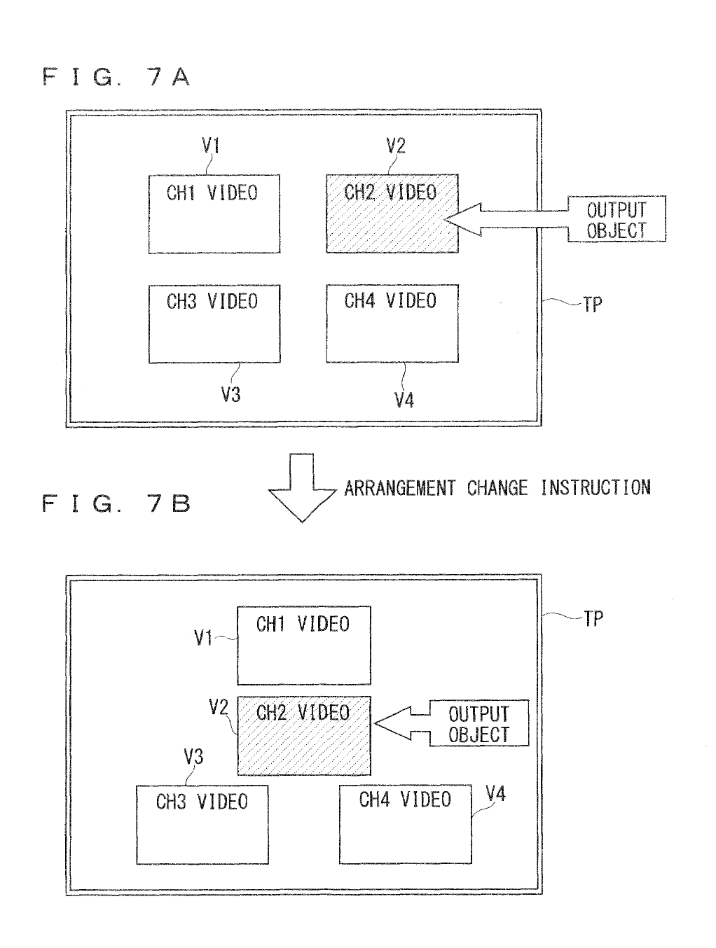

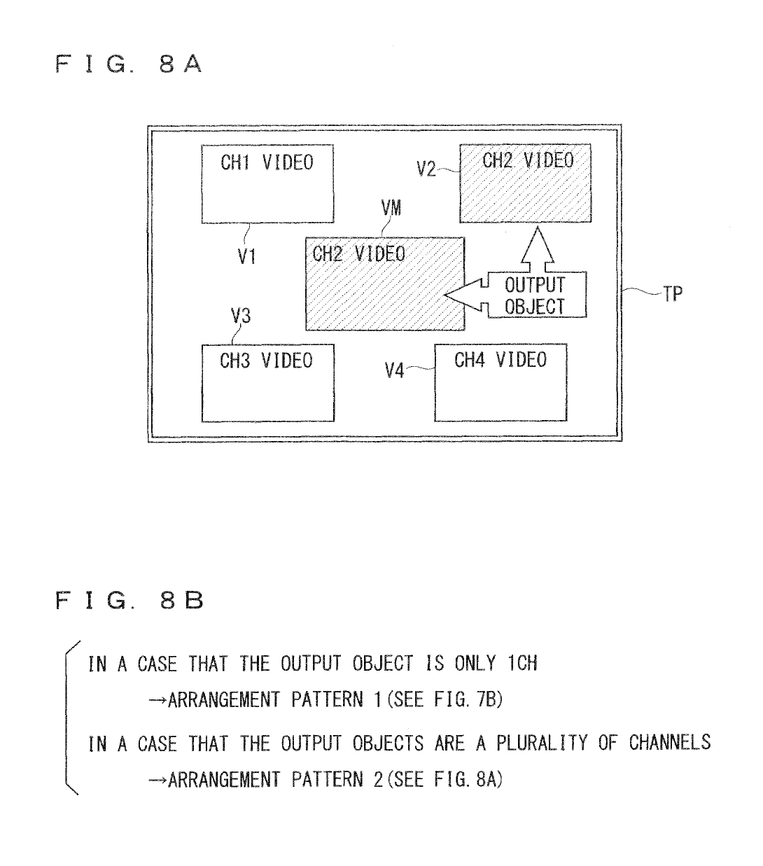

Referring to FIGS. 7 and 8, the arrangement change of AV signal designating areas will be explained. In the description below, the AV processing apparatus 30 is exemplified with inputs of the four video signals ch1-4. FIG. 7 is an explanatory diagram of an arrangement change pattern 1. For example, in the arrangement change pattern 1, when the video signal of ch2 is an output object among the ch1-4 as shown in FIG. 7A (the video signal included in the output AV signal is the ch2 only), and when the arrangement change button BT1 is pressed, the display control unit 350 changes the arrangement shown in FIG. 7B. Thus, the video signal designating area V2 corresponding to the video signal of the ch2 as an output object is arranged at around the center with respect to other video signal designating areas V1, V3 and V4. With this arrangement, the arrangements of the other video signal designating areas V1, V3 and V4 are changed so as to make the distances from the video signal designating area V2 approximately equal. With these arrangements, the other video signal designating areas V1, V3 and V4 are reduced in size so as not to overlap each video signal designating area V. In a case that there exists a plurality of channels having video signals included in the output AV signal, a plurality of video signal designating areas V are arranged around at the center with respect to the other video signal designating areas V.

FIG. 8A is an explanatory diagram of an arrangement change pattern 2. In the arrangement change pattern 2, when the arrangement change is instructed in the state shown in FIG. 7A, the video signal designating area V2 corresponding to the video signal of the ch2 as an output object is arranged at around the center with respect to other video signal designating areas V1, V3 and V4. Regarding reducing the size of other video signal designating areas V1, V3 and V4 so as not to overlap each video signal designating area V, the reduction is performed in a similar manner with the arrangement change pattern 1, but it differs in that the size of the video signal designating area V2 is enlarged (a video signal designating area VM). Also, an output video signal designating area VM (a video signal designating area of video signal as an output object) corresponding to the video signal of the ch2 is added while the arrangement of the video signal designating area V2 being remained, instead of moving the video signal designating area V2 at around the center as the arrangement change pattern 1.

FIG. 8B is an explanatory diagram of an arrangement change pattern 3. In the arrangement change pattern 3, when the output object is one channel only, the arrangement change of the arrangement change pattern 1 (see FIG. 7B) is performed, whereas when the output objects are a plurality of channels, the arrangement change of the arrangement change pattern 2 (see FIG. 8A) is performed. When the output video signal designating area VM corresponding to a plurality of channels is displayed, the mixing rate and the switching rate are determined according to the touch position and contained rate of the signals of the channels included in the output video signal designating area VM.

Thus, operability is enhanced by arranging an AV signal designating area corresponding to an AV signal (an output AV signal) as a current edit object at around the center with respect to other AV signal designating areas. For example, in a case that the output AV signal is the video signal and a video of the video signal is wiped to another video, it is easy to switch to any other video signals because AV signal designating areas corresponding to other video signals are arranged therearound. Even in a case that the user withdraws his/her finger from the touch panel TP, the AV signal designating area corresponding to the AV signal as an edit object is not lost.

The instruction for the arrangement change may be performed with other operations such as touching a predetermined position on the touch panel TP, besides pressing the arrangement change button BT1. The arrangement change pattern may be set fixedly to any one of the above three patterns, or the user may set which arrangement pattern is selected.

As described above, according to the embodiment, the mixing process and the switching process can be performed based on the touch position on the touch panel TP or the movement of the touch position by displaying a plurality of AV signal designating areas on the touch panel TP. In other words, as an arbitrary AV signal designating area is touched, an AV signal corresponding to the area is output mainly. As the touch position is moved between two AV signal designating areas, a switching between the two AV signals can be performed. As such, it is possible to perform the edit process feasibly with an intuitive operation.

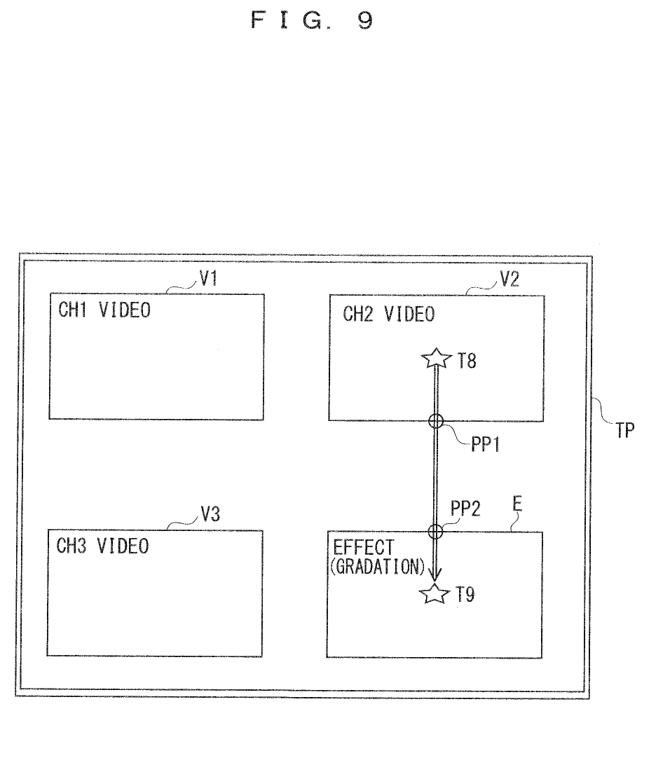

In the above embodiment, the edit process such as the mixing process or the switching process is exemplified by displaying a plurality of AV signal designating areas on the touch panel TP, but it is possible to perform an effect process as one of the edit processes. In this case, as shown in FIG. 9, an effect designating area E is provided on the touch panel TP. FIG. 9 shows that the video signal designating areas V1-V3 corresponding to video signals of the ch 1-3 and the effect designating area E for designating an effect (gradation) are shown on the touch panel TP. For example, the second operation mode is set, and, in this state, a touch position T8 is touched within the video signal designating area V2, the video signal of ch2 is output at 100%. With that state, when a touch position T9 is touched, the video signal of the ch2 is affected according to the effect of gradation because the touch position T9 is in the effect designating area E.

On the other hand, when the touch position is moved from the touch position T8 to the touch position T9, the effect of gradual gradation is adapted from the point beyond a position PP1 (a boundary between the video signal designating area V2 and the area outside thereof) on a moving path, and when the touch position arrives at a position PP2 (a boundary between the effect designating area E and the area outside thereof) on the moving path, the effect of gradation is adapted at 100% effect applying rate. Then, the 100% effect is maintained from the position PP2 to the touch position T9.

Thus, it is possible to operate intuitively not only the mixing process or the switching process but also the effect process by providing the effect designating area E on the touch panel TP. With this configuration, expressiveness by and usability for users such as DJs or VJs seeking for many different musical expressions or video expressions can be enhanced.

As other effects for video signals, video effects (scaling, puzzle, coloring, gradation, strobe, lens, wipe, inversion, negative, and the like) can be adapted. As other effects for audio signals, audio effects such as delay, reverb, and flanger can be adapted. It may be possible to adapt effect by which users feel the same (relevant each other) to audio and video signals by corresponding one effect designating area E to effects for the video signal and the audio signal (for example, wipe and flanger).

Further, one or more effect designating areas E may be provided, and the first operation mode can be adapted (the reference point P is provided and the applying rate of the effect is determined according to the distances from the reference point P), in place of the second operation mode.

In the above embodiment, the case where the video signals are input is exemplified, but, as shown in FIG. 10A, it is possible to provide audio signal designating areas A corresponding to audio signals and video signal designating areas V corresponding to video signals on the touch panel TP simultaneously. FIG. 10A shows a case where an audio signal designating area A1 corresponding to an audio signal input to the ch1, an audio signal designating area A2 corresponding to an audio input to the ch2, a video signal designating area V3 corresponding to a video signal input to the ch3 and a video signal designating area V4 corresponding to a video signal input to the ch4 are displayed.

Thus, it is easily possible to operate music and video by providing the audio signal designating areas A and the video signal designating areas V on the touch panel TP simultaneously, regardless of expertise field such as DJ and VJ. Further, higher performance can be achieved because time lag of music and video vanishes by operating music and video by one person.

In a case that audio signal designating areas A are provided, as shown in FIG. 10A, it is preferable that a channel number, a song title “oooo”, BPM value or the like be displayed in each of audio signal designating area A as information for specifying the audio signal. With the information, the user can acknowledge the audio signal corresponding to the area.

By applying the example of FIG. 10A to that of FIG. 9, it is also possible to provide the audio signal designating areas A, the video signal designating areas V, and the effect designating area E on the touch panel TP simultaneously.

Also, in the above embodiment, a case where each AV signal designating area and the effect designating area E is separated is exemplified, but, as shown in FIG. 10A, it is possible to abut each area (in the example shown, the video signal designating areas V1-V4). Note that, in this case, when the second operation mode is set, operations such as switching video signals are difficult. Therefore, it is preferred that only the first operation mode can be set.

Further, an arrangement of each area is arbitrary, in which a portion of each area may be overlapped, or two types of signals are output by designating in one area where two areas are completely superposed.

Further, DJV equipment is exemplified used in a club and the like as the AV processing apparatus 30, but the invention can be applied to an apparatus and a program (an audio/video mixer, an audio/video controller, an audio/video process application or the like) which are input with a plurality of AV signals and can edit them, besides the DVJ equipment. In other words, the invention can be applicable to an apparatus which processes audio signals only or video signals only, besides an apparatus which processes audio and video signals.

It is possible to provide each unit and each function of the AV processing apparatus 30 described above as program. It is also possible to provide recording media stored with the program. As the recording media, a CD-ROM, a flash ROM, a memory card (a compact flash (registered), a smart media, a memory stick or the like), a compact disc, a magneto-optical disc, a digital versatile disc, a flexible disc, and a hard disc or the like can be used.

The invention includes various modified embodiments without deviating from the scope of the invention in terms of the system structure of the AV processing system SY, and the structure and process of the AV processing apparatus 30.

1.-9. (canceled)

10. An AV processing apparatus comprising:
an input unit that is used to receive a plurality of AV signals as a audio signal or a video signal;
an operating unit that includes a touch panel having a display function and is used for an edit operation of a plurality of AV signals with the touch panel having the display function;
a display control unit that controls to display on the touch panel having the display function;
an output AV signal generating unit that performs edit processes including a mixing process and a switching process on a plurality of AV signals based on the edit operation by the operating unit, and generates an output AV signal as an output object; and
an output unit that outputs the output AV signal generated by the output AV signal generating unit,
wherein the display control unit displays a plurality of AV signal designating areas which is used to designate an output of each AV signal on the touch panel having the display function corresponding to a plurality of AV signals input from the input unit, and the output AV signal generating unit performs the mixing process of a plurality of AV signals based on a touch position on the touch panel having the display function and performs the switching process of a plurality of AV signals based on a movement of the touch position.

11. The AV processing apparatus according to claim 10, wherein the display control unit determines arrangements of a plurality of AV signal designating areas based on the number of the AV signals input from the input unit.

12. The AV processing apparatus according to claim 11, wherein the display control unit displays a plurality of AV signal designating areas by arranging at a position corresponding to each apex of a polygon according to the number of the AV signals.

13. The AV processing apparatus according to claim 10, wherein the display control unit displays a video of a video signal on a corresponding AV signal designating area when the AV signal is the video signal.

14. The AV processing apparatus according to claim 10, wherein each AV signal designating area has a reference point as reference that is used to determine the mixing rate in the mixing process and the switching rate in the switching process, and the output AV signal generating unit determines the mixing rate or the switching rate of each AV signal corresponding to each AV signal designating area based on a distance between the touch position and each reference point provided in each AV signal designating area with respect to the touch position or the movement of the touch position.

15. The AV processing apparatus according to claim 10, wherein the output AV signal generating unit sets the output of the AV signal corresponding to the AV signal designating area at 100% with respect to the touch position or the movement of the touch position inside the AV signal designating area, and determines the mixing rate or the switching rate of each AV signal corresponding to each AV signal determining area based on a minimum distance from the touch position to each AV signal designating area with respect to the touch position or the movement of the touch position outside the AV signal designating area.

16. The AV processing apparatus according to claim 10, wherein each AV signal designating area has a reference point as reference that is used to determine the mixing rate in the mixing process and the switching rate in the switching process,
wherein an operation mode setting unit is provided that sets either a first operation mode or a second operation mode; the first operation mode determining the mixing rate or the switching rate of each AV signal corresponding to each AV signal designating area based on a distance between the touch position and each reference point provided in each AV signal designating area with respect to the touch position or the movement of the touch position; and the second operation mode setting the output of the AV signal corresponding to the AV signal designating area at 100% with respect to the touch position or the movement of the touch position inside the AV signal designating area and determining the mixing rate or the switching rate of each AV signal corresponding to each AV signal designating area based on the minimum distance from the touch position to each AV signal designating area with respect to the touch position or the movement of the touch position outside the AV signal designating area;
and wherein the output AV signal generating unit performs the mixing process or the switching process based on a setting by the operation mode setting unit.

17. The AV processing apparatus according to claim 10 further comprising an arrangement change instructing unit that is used to instruct an arrangement change of each AV signal designating area on the touch panel having the display function, wherein the display control unit changes an arrangement of one or more AV signal designating areas corresponding to one or more AV signals included in the output AV signal at around a center with respect to other AV signal designating areas based on an instruction by the arrangement change instructing unit.

18. The AV processing apparatus according to claim 10, wherein the edit process includes an effect process that applies an effect on the output AV signal, the display control unit displays one or more effect designating areas provided per effect on the touch panel having the display function, and the output AV signal generating unit performs the effect process on the output AV signal based on the touch position or the movement of the touch position on the touch panel having the display function.

19. A program causing a computer to function as each unit of the AV processing apparatus according to claim 10.
